(19) United States
(12) Patent Application Publication
(10) Pub. No.: US 2009/0027010 A1
(43) Pub. Date: Jan. 29, 2009

(54) PORTABLE COMMUNICATION DEVICE AND METHOD FOR CHARGING THROUGH DISCERNMENT OF CHARGING CABLE

(75) Inventors: Jung-Su HA, Gumi-si (KR); Kwang-Sik CHA, Daegu (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/171,631

(22) Filed: Jul. 11, 2008

(30) Foreign Application Priority Data
Jul. 25, 2007 (KR) 2007-74494

(51) Int. Cl. H02J 7/00

(52) U.S. Cl. 320/138

(57) ABSTRACT

A portable communication device and method for charging through discernment of a charging cable are provided. When the portable communication device is connected to an external charging device through a connector in order to charge a power source in the portable communication device, a configuration signal is received from the external charging device through a positive data line and a negative data line of the connector, a logic characteristic value is output according to the received configuration signal, the charging cable is discerned by analyzing a current characteristic through connection with a resistance circuit according to the on/off state of a switch which operates according to the logic characteristic value, and a control operation is performed such that a battery is charged from the external charging device through the corresponding charging cable.

### PRIORITY

This application claims the benefit under 35 U.S.C. §119(a) of a Korean patent application filed with the Korean Intellectual Property Office on Jul. 25, 2007 and assigned Serial No. 2007-74494, the entire disclosure of which is hereby incorporated by reference.

### BACKGROUND OF THE INVENTION

1. Field of the Invention

The present invention relates to a portable communication device and method for charging the device. More specifically, the present invention relates to a portable communication device and method for charging through discernment of a charging cable.

2. Description of the Related Art

Currently, the use of portable communication devices such as mobile phones is widespread. And, as the portable communication devices are continuing to be provided with more and more advanced functions, the market for such devices continues to extend.

Recently, portable communication devices have also been provided with advanced components such as a high-performance controller, a large-capacity memory, and a colorful display. These advanced components have become so popular as to have effectively become requirements for general portable devices. With these portable communication devices and their advanced components, it has become easier to generate, store and use a large amount of data such as personal information, and it has become possible to generate, store and reproduce various multimedia data.

An advantage of a portable communication device having advanced components as described above is that it may be used to provide many functions typically provided by a Personal Computer (PC). Accordingly, users connect their portable communication devices to personal computers to perform data communication and transfer in order to store and manage numerous data files and information.

Also, since recent portable communication devices have been equipped with internal charging circuits, which are popular because they provide enhanced portable convenience, a portable communication device has only to be connected to an external power source in order to charge the battery thereof. That is, when an appropriate external power source is connected to the power unit of a portable communication device, the battery of the device is automatically charged. Therefore, it becomes unnecessary for the user to carry a large charging device in addition to the portable communication device.

For such charging, a method of using a Travel Adaptor (TA) is widely used. The TA includes an interface to be connected to a communication port (e.g. a universal 24-pin receptacle, etc.) of a portable communication device, and a means for converting commercial power into charging power. When the travel adaptor has been connected between a commercial power outlet and the communication port of a portable communication device, a charging operation is performed.

FIG. 1 is a view illustrating a conventional connection state between a charging cable and a portable communication device.

As illustrated in FIG. 1, a portable communication device is connected to a dedicated charging cable 11 through an external connector 12.

A charging power pin of the charging cable 11 is connected to a charging input pin of the external connector 12, and a ground terminal of the charging cable 11 is connected to a ground terminal of the external connector 12.

A power supply unit 13 of the portable communication device can receive charging power through the external connector 12 and charge a battery 14. The power supply unit 13 also supplies power to a central processing unit 15.

However, there is an inconvenience in that the user must carry a charging device in order to charge the portable communication device when the charge of the battery becomes depleted.

As discussed above, users typically connect their portable communication devices to their PC for data communication. Recently, considering that a time period during which a portable communication device is in a Universal Serial Bus (USB) connection with the PC is increasing, there has been an attempt to utilize power supplied through a USB port of a PC as charging power for a portable communication device. For this reason, various charging cables have been developed that enable portable communication devices to be charged by computers, such as desk top or laptop computers that are widely used in most homes, offices, etc.

FIG. 2 is a view illustrating a conventional connection state between a portable communication device and a USB charging/data cable.

A portable communication device is connected to a USB charging/data cable 21 through an external connector 22.

A charging power pin of the USB charging/data cable 21 is connected to a charging input pin of the external connector 22, and a ground terminal of the USB charging/data cable 21 is connected to a ground terminal of the external connector 22.

In addition, terminals USB_D+ and USB_D− of the USB charging/data cable 21 are connected to input terminals D+ and D− of a central processing unit 25 through terminals USB_D+ and USB_D− of the external connector 22 so as to communicate with an external computer.

A power supply unit 23 of the portable communication device can receive charging power through the external connector 22 and charge a battery 24. The power supply unit 23 also supplies power to the central processing unit 25.

A difference between a dedicated charging device and a USB charging/data cable is that the USB charging/data cable can transmit/receive data, as well as provide power for charging a battery.

However, while the dedicated charging device can stably supply sufficient power to a portable communication device, a PC connected through a USB charging/data cable may not supply sufficient charging power. That is, depending on the number of devices connected to other USB ports and their connected or activity states, the power supplied by the PC may be insufficient.

Furthermore, when a portable communication device is charged using a PC, the current supplied by the PC varies according to the state of charging power. If the USB supply power of a PC is initially insufficient, and then charging current supplied to a portable communication device is suddenly increased, both the internal circuits of the PC and the portable communication device may be subjected to damage due to an electrical surge.

### SUMMARY OF THE INVENTION

An aspect of the present invention is to address at least the above-mentioned problems and/or disadvantages and to provide at least the advantages described below. Accordingly, an aspect of the present invention is to provide a portable communication device and method for charging through discernment of a charging cable. Another aspect of the present invention is to provide a portable communication device and method which can accurately discern a charging cable connected to charge a power source in the portable communication device by switching on or off according a logic characteristic value output from a logic circuit, and analyzing the current characteristic of current passing through a resistance circuit according to the on/off operation of the switch.

In addition, another aspect of the present invention is to provide a portable communication device and method for charging a power source in the portable communication device with the charging cable accurately discerned, thereby preventing the portable communication device or battery from being damaged due to unstable power of a charging device.

In accordance with an aspect of the present invention, a portable communication device for charging through discernment of a charging cable is provided. The portable communication device includes an external connector connected to a charging device in order to charge a power source in the portable communication device, a charging unit for charging a battery with power which is input from the charging device through the external connector, the battery which is charged with the power provided through the charging unit and supplies power required in the portable communication device and a controller for discerning the charging cable by analyzing a current characteristic according to a configuration signal input from the charging device through the external connector, and controlling the battery to be charged from the charging device through the discerned charging cable.

In accordance with another aspect of the present invention, a method for charging through discernment of a charging cable in a portable communication device is provided. The method includes connecting the portable communication device to a charging device through an external connector in order to charge a power source in the portable communication device, receiving a configuration signal from the charging device through a positive data line and a negative data line of the external connector, outputting a logic characteristic value according to the received configuration signal, connecting a resistance circuit unit by performing an on/off operation according to the logic characteristic value, discerning the charging cable by analyzing a current characteristic of the connected resistance circuit unit and controlling a battery to be charged from the charging device through the discerned charging cable.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a view illustrating a conventional connection state between a charging cable and a portable communication device;

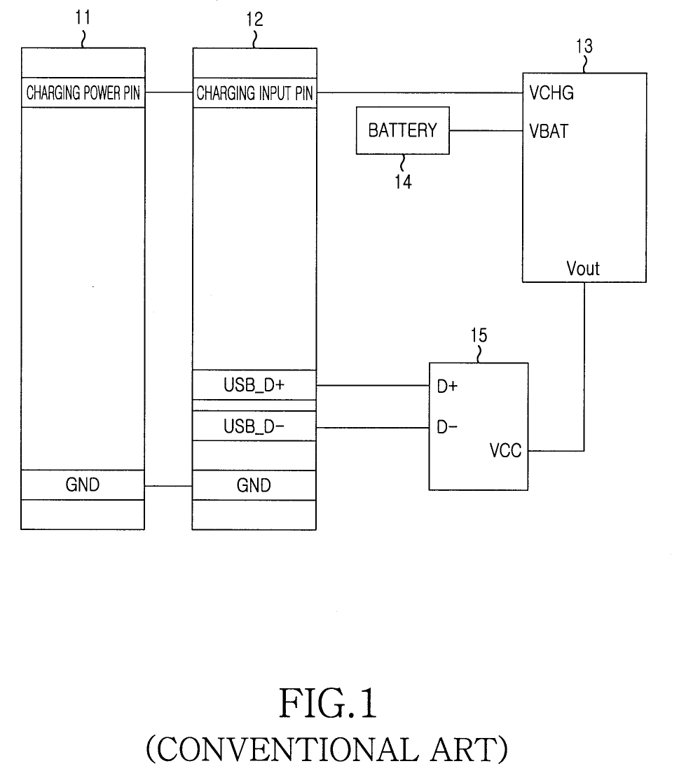

FIG. 2 is a view illustrating a conventional connection state between a portable communication device and a USB charging/data cable;

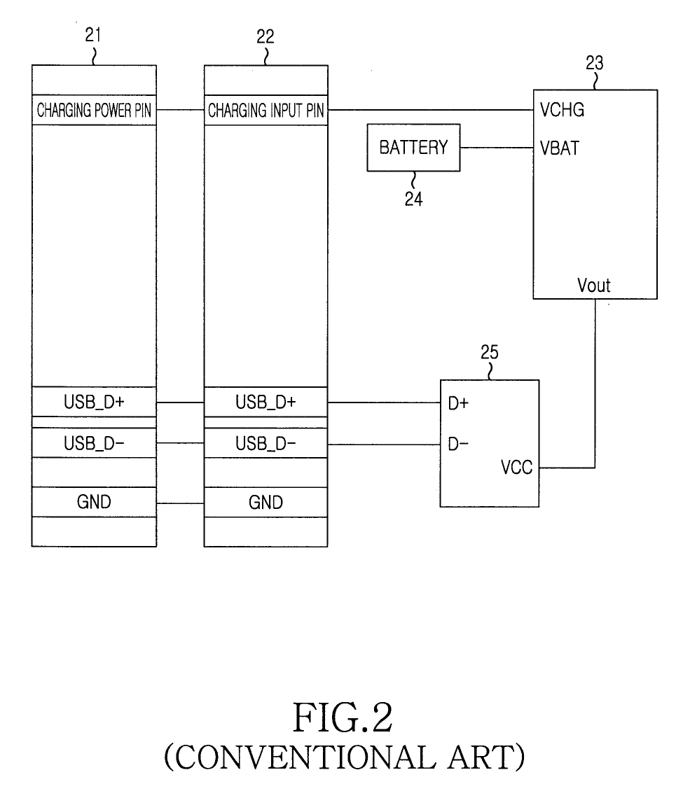

FIG. 3 is a block diagram illustrating a configuration of a portable communication device having a charging function through discernment of charging cables according to an exemplary embodiment of the present invention;

FIGS. 4A and 4B are graphs showing examples of a configuration signal which is transmitted from the charging device to the positive data (D+) line and the negative data (D−) line at the same time according to an exemplary embodiment of the present invention;

FIG. 5 is a circuit diagram illustrating the configuration of a controller in a portable communication device according to an exemplary embodiment of the present invention;

FIG. 6 is a circuit diagram illustrating the configuration of a controller in a portable communication device according to another exemplary embodiment of the present invention; and

FIG. 7 is a flowchart illustrating a method for discerning a charging cable by a portable communication device according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

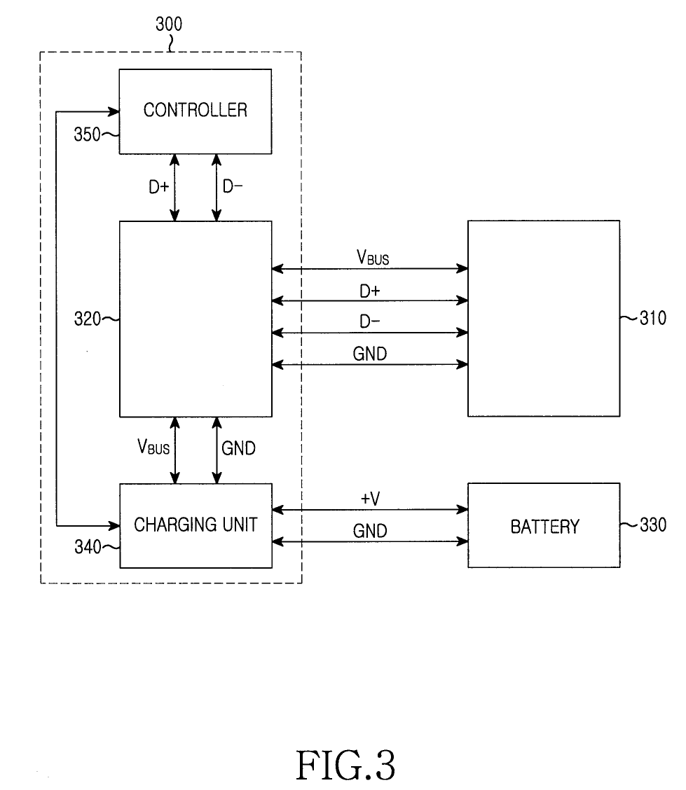

FIG. 3 is a block diagram illustrating a configuration of a portable communication terminal having a charging function through discernment of charging cables according to an exemplary embodiment of the present invention.

According to an exemplary embodiment of the present invention, a portable communication terminal 300 includes an external connector 320, a battery 330, a charging unit 340 and a controller 350. The external connector 320 is connected to a power source (not shown) within the portable communication device 300 to supply power to the power source from an external charging device (not shown). The battery 330, which is charged with power received from the charging unit 340, supplies power required by the portable communication device 300. The charging unit 340 is provided for charging the battery 330 with power received from the external charging device through the external connector 320. The controller 350 performs a control operation such that the battery 330 is charged with power received from the charging device through the external connector 320. Also, the controller 350 discerns a charging cable 310 by analyzing a current characteristic based on a configuration signal of the charging device.

More specifically, the portable communication device 300 discerns a charging cable 310 using a configuration signal of a charging device when the charging device has been connected to the portable communication device 300 through the external connector 320. Also, the portable terminal device 300 receives power from the charging device in order to charge a power source within the portable communication device 300.

In an exemplary embodiment, the external connector 320 may be a standard 4-pin USB connector, including a Voltage Bus (VBus) line, a positive Data (D+) line, a negative Data (D−) line, and a ground line, as described in the Universal Serial Bus Specification, Revision 2.0, published Apr. 27, 2000.

The VBus line conveys a power signal of 3.3 volts from the charging device. The D+ line and the D− line convey a configuration signal of the charging device.

In this case, when the charging device corresponds to a notebook computer or a desktop computer, a configuration signal, which can vary from 3.3 volts to 0 volts through the D+ line of the USB cable and can vary from 0 volts to 3.3 volts through the D− line, is input.

In contrast, when the charging device corresponds to a normal or dedicated charging device, a configuration signal which is maintained at 3.3 volts in both the D+ line and D− line of a travel adaptor (TA) cable is input.

The ground line is connected to a ground voltage of the charging device, but may be connected to a different ground source.

The charging unit 340 can receive power from the charging device through the VBus line and ground line of the external connector 320. Using the received power, the charging unit 340 charges the battery 330 and supplies power to the controller 350. In this case, the battery 330 may be a rechargeable Lithium-Ion battery, or a different type of rechargeable battery.

The controller 350 discerns the charging cable 310 by analyzing the current characteristics of a configuration signal, which is input from the charging device through the D+ line and D− line of the external connector 320. Based on the detected charging cable 310, the controller 350 performs a control operation such that power is received from the corresponding charging device through the charging cable 310, and the battery 330 is charged with the received power.

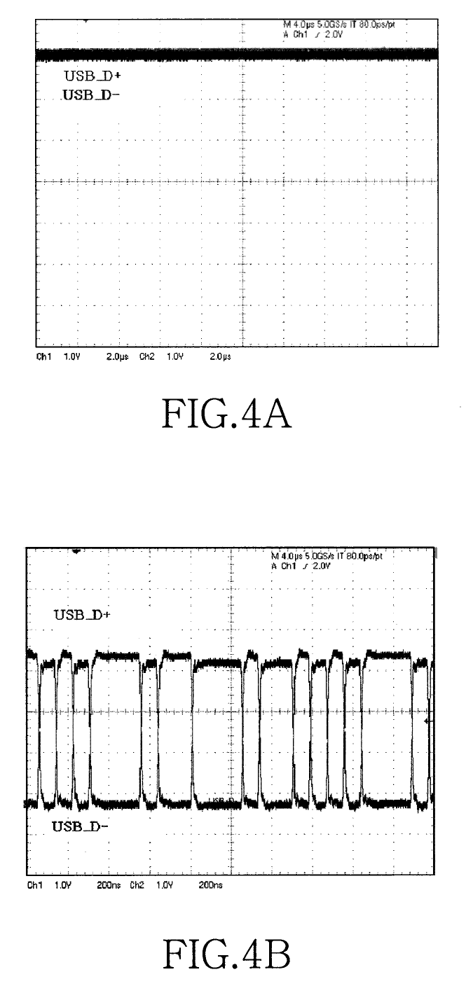

FIGS. 4A and 4B are graphs showing examples of a configuration signal which is transmitted from the charging device to the D+ line and the D− line at the same time according to an exemplary embodiment of the present invention.

FIG. 4A shows two waveforms representing a configuration signal, which is input through a TA cable from the charging device, as a function of time with respect to each of the D+ line and D− line. The configuration signal of the charging device, which is shown in FIG. 4A, is a periodic digital signal having a constant voltage of 3.3 volts.

FIG. 4B shows two waveforms representing a configuration signal, which swings from 3.3 volts (high) to 0 volts (low) and from 0 volts (low) to 3.3 volts (high) and is input through a USB cable from the charging device, as a function of time with respect to each of the D+ line and D− line. As described above, the voltage and waveform of a configuration signal enables the operating characteristics of the charging cable 310 to be discerned.

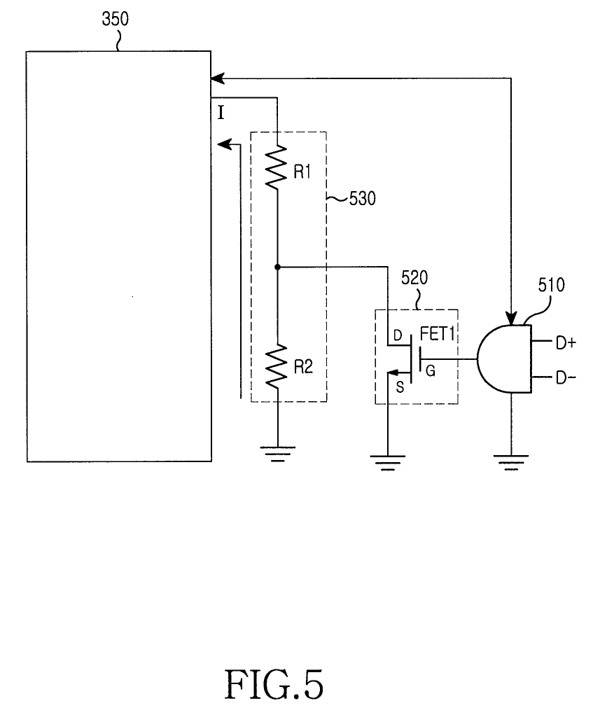

FIG. 5 is a circuit diagram illustrating a configuration of a controller in a portable communication device according to an exemplary embodiment of the present invention.

Referring to FIG. 5, the controller 350 includes a logic circuit unit 510, a switch unit 520, and a resistance circuit unit 530. When the controller 350 is connected to a charging device through an external connector 320, the logic circuit unit 510 outputs a logic characteristic value (e.g. high or low) according to a configuration signal of the charging device. In an exemplary implementation, the configuration signal of the charging device is input to the logic circuit unit 510 through the D+ line and the D− line. Using the value of the configuration signal received through the D+ line and the D− line, the logic circuit unit 510 outputs a logic characteristic value to the switch unit 520. The switch unit 520 performs an on/off operation according to the logic characteristic value output from the logic circuit unit 510. Based on the on/off switching of the switch unit 520, the resistance of the resistance unit 530 is changed. By varying its resistance, the resistance circuit unit 530 enables the controller 350 to analyze the current characteristic according to the on/off operation of the switch unit 520. In turn, the analysis can be used to determine the type of cable and thus external charging device that is connected to the portable communication device.

More specifically, the controller 350 analyzes characteristics of the current which passes through the resistance circuit unit 530. Again, the resistance of the resistance unit 530 varies according to the on/off operation of the switch unit 520 which in turn is based on the logic characteristic value output from the logic circuit unit 510.

The logic circuit unit 510 is configured to recognize a configuration signal of a charging device that is input through the D+ line and the D− line. In an exemplary embodiment as illustrated in FIG. 5, the logic circuit unit 510 is a 2-input 1-output element implemented by an AND gate. The logic circuit unit 510 outputs a logic value (i.e. “0” or “1”) by using binary logic corresponding to input information. Of course, the AND gate illustrated in FIG. 5 as the logic circuit unit 510 is merely for example and not to be construed as limiting. That is, other and/or different types of logic gates may also be used, for example logic gates such as OR, NOR, NAND and the like, as well as combinations of logic gates as needed.

The exemplary embodiment as illustrated in FIG. 5 includes an AND gate installed to be connected to the switch unit 520. The AND gate of FIG. 5 will now be described in detail with reference to Table 1.

TABLE 1

| D+ | D− | Output |
|---|---|---|
| LOW | LOW | LOW |
| LOW | HIGH | LOW |
| HIGH | LOW | LOW |
| HIGH | HIGH | HIGH |

As illustrated in Table 1 and commensurate with the function of an AND gate, when both the D+ line and the D− line, as respective inputs to the logic circuit unit 510, are in a logic HIGH state, the logic circuit unit 510 outputs a logic HIGH value. That is, when receiving continuous configuration signals of 3.3 volts through both the D+ line and the D− line from the charging device, the logic circuit unit 510 outputs a high logic signal to the switch unit 520. Alternatively, if either the D+ line or the D− line are in a logic LOW state (e.g. at 0 volts), the logic circuit unit 510 outputs a low logic signal to the switch unit 520.

The switch unit 520 is switched on or off according to a logic characteristic value output from the logic circuit unit 510. In an exemplary embodiment, the switch unit 520 is implemented with an N-channel field effect transistor (FET). Of course, this is merely for example and not to be construed as limiting. That is, other and/or different types of switches may also be used, for example P-channel devices, bipolar devices, thyristors and the like.

The field effect transistor FET1 is switched on when it receives a high logic signal as input from the logic circuit unit 510. In such a case, the FET1, having its drain (D) connected at an electrical junction between serial resistors R1 & R2 in the resistance circuit unit 530, creates a current path between the electrical junction and ground. That is, when it is energized, the FET1 provides a low resistance path in parallel with resistor R2, effectively removing R2 from the serial connection with R1. Of course, the resistance characteristics of FET1, R1 and R2 may be altered depending on demands or sensitivity of the controller 350, or other system design requirements as needed.

The controller 350 analyzes the current characteristic “I” of current passing though the resistance circuit unit 530. In the described situation in which the field effect transistor FET1 is energized and thus R2 is effectively removed from the resistance circuit unit 530, the current I is as shown in equation 1. That is, when a TA cable is connected to the portable communication device from the charging device such that both the D+ line and the D− line are in a logic high state, the output of the logic circuit unit 510 is high so that the FET1 is energized. When energized, FET1 effectively removes R2 from the path of current passing through the resistance circuit unit 530 so the current I is determined by equation 1.

I=V/R1 (1)

In equation 1, “I” represents a current value, “V” represents a voltage value, and “R1” represents a resistance value.

Therefore, the controller 350 discerns a TA cable according to the current characteristic “I” analyzed through the resistance circuit unit 530.

Thereafter, the controller 350 performs a control operation such that power is received from a normal or dedicated charging device through the discerned TA cable, and the battery 330 is charged with the received power.

Alternatively, the logic circuit unit 510 may receive a configuration signal from a charging device that swings from 3.3 volts (high) to 0 volts (low) through the D+ line, and swings from 0 volts (low) to 3.3 volts (high) through the D− line. In such a case and referring to Table 1, because the two inputs to the logic circuit unit 510 are never high at the same time, the logic circuit unit 510 outputs a low logic signal to the switch unit 520.

Upon receipt of a low logic signal from the logic circuit unit 510, the switch unit 520 is switched off. That is, when the switch unit 520 is implemented with an N-channel transistor FET1 as illustrated in FIG. 5, the low input value input will cause the transistor FET1 to turn off. In such a case, the FET1 provides effectively an open circuit as seen across its source (S) and drain (D) so that resistor R2 is again in the path of current I through the resistance circuit unit 530.

In this case, the controller 350 analyzes the current characteristic “I” of current passing though the serial resistors R1 and R2 of the resistance circuit unit 530, according to the switched-off switch unit 520, as shown in equation 2.

I=V/R1+R2 (2)

The controller 350 discerns a USB cable according to the current characteristic “I” analyzed through the serial resistors R1 and R2 in the resistance circuit unit 530.

Thereafter, the controller 350 performs a control operation such that power is received through the discerned USB cable from a charging device, such as a notebook computer or a desktop computer, and the battery 330 is charged with the received power.

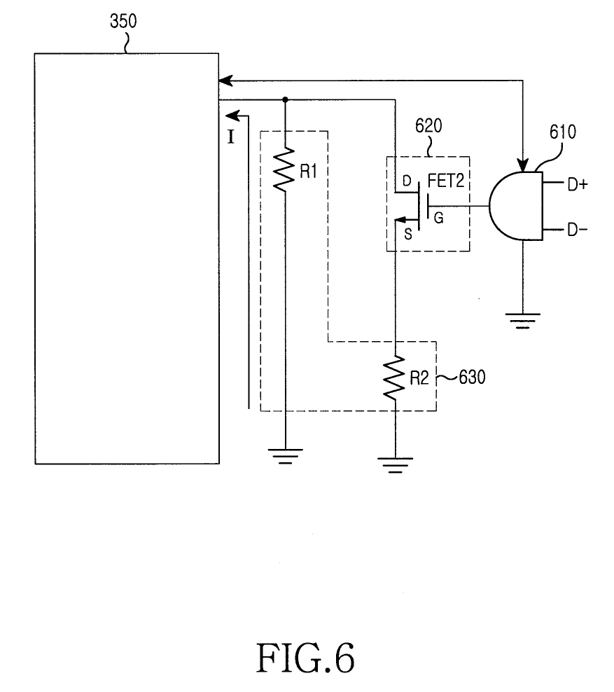

FIG. 6 is a circuit diagram illustrating a configuration of a controller in a portable communication device according to another exemplary embodiment of the present invention.

When a logic circuit unit 610 has received a configuration signal of 3.3 volts (high) through both the D+ line and the D− line from a charging device, the logic circuit unit 610 outputs a high logic signal to a switch unit 620.

The switch unit 620 is switched on according to the high logic signal output from the logic circuit unit 610. As in the previous exemplary embodiment, the switch unit 620 illustrated in FIG. 6 is implemented by an N-channel Field Effect Transistor, FET2. Accordingly, when the FET2 is turned on, it provides a current path from the controller 350 through the resistor R2 to ground. Based on this current path and the configuration of resistor R1 (also between controller 350 and ground), the transistor FET2 creates a parallel current path through resistors R1 and R2 in a resistance circuit unit 630.

The controller 350 analyzes the current characteristic “I” of current passing though the parallel resistors R1 and R2 of the resistance circuit unit 630, which are connected by the switch unit 620, as shown in equation 3. In this case, the current characteristic “I” may be adjusted according to the values of the parallel resistors R1 and R2 in the resistance circuit unit 630.

I=V/(R1//R2) (3)

The controller 350 discerns a TA cable according to the current characteristic “I” analyzed through the parallel resistors “R1/R2” in the resistance circuit unit 630.

Thereafter, the controller 350 performs a control operation such that power is received from a normal or dedicated charging device through the discerned TA cable, and the battery 330 is charged with the received power.

Alternatively, when the logic circuit unit 610 has received a configuration signal, which swings from 3.3 volts (high) to 0 volts (low) through the D+ line, and swings from 0 volts (low) to 3.3 volts (high) through the D− line, from the charging device, the logic circuit unit 610 outputs a low logic signal to the switch unit 620.

Then, the switch unit 620 is switched off according to the low logic signal output from the logic circuit unit 610. When it is switched off, FET2 effectively creates an open circuit such that resistor R2 is no longer in the path of current I from controller 350.

The controller 350 analyzes the current characteristic “I” of current passing though the resistor R1 in the resistance circuit unit 630, according to the switched-off switch unit 620, as shown in equation 4.

I=V/R1 (4)

The controller 350 discerns a USB cable according to the current characteristic “I” analyzed through the parallel resistor R1 in the resistance circuit unit 630.

Thereafter, the controller 350 performs a control operation such that power is received through the discerned USB cable from a charging device, such as a notebook computer or a desktop computer, and the battery 330 is charged with the received power.

Hereinafter, an operation of a portable communication device according to an exemplary embodiment of the present invention will be described in more detail.

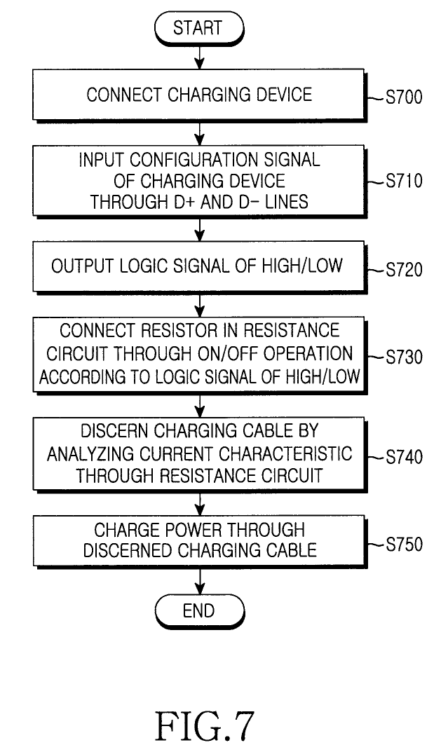

FIG. 7 is a flowchart illustrating a method for discerning a charging cable by a portable communication device according to an exemplary embodiment of the present invention.

According to an exemplary embodiment of the present invention, when the portable communication device is connected to a charging device through an external connector in step 700, the portable communication device receives a configuration signal of the charging device through the D+ line and the D− line in step 710.

Thereafter, a logic circuit unit outputs a logic characteristic value to a switch unit according to the configuration signal of the charging device in step 720.

A controller is connected to a resistance circuit unit. Furthermore, a resistance of the resistance unit varies according to the switching state of the switch unit, which is switched on or off according to the logic characteristic value output from the logic circuit unit, in step 730.

Thereafter, the controller analyzes the current characteristic “I” of the resistance circuit unit, which is varied according to the switching state of the switch unit, and discerns the charging cable in step 740.

For example, the controller may be configured in such a manner that, when configuration signals of 3.3 volts through both the D+ line and the D− line are received from the charging device, the logic circuit unit outputs a high logic signal to the switch unit, so that the switch unit is switched on and is connected with a serial resistor (e.g. 660 Ω) in the resistance circuit unit.

Thereafter, the controller analyzes the current characteristic of current (e.g. 500 mA) passing though the serial resistor (660 Ω) in the resistance circuit unit, which is connected by the switch unit, as shown in equation 5.

500 mA=3.3V/660 (5)

The controller discerns a Travel Adaptor (TA) cable according to the current characteristic of 500 mA analyzed through the serial resistor (660 Ω) in the resistance circuit unit.

Also, when the controller has received a configuration signal, which swings from 3.3 volts (high) to 0 volts (low) through the D+ line, and swings from 0 volts (low) to 3.3 volts (high) through the D− line, from the charging device, the logic circuit unit outputs a low logic signal, and thus the switch unit is switched off.

Thereafter, the controller analyzes the current characteristic of current (300 mA) passing though the serial resistors (600 Ω+400 Ω) of the resistance circuit unit according to the switched-off switch unit, as shown in equation 2.

300 mA=3.3V/600+400 (6)

The controller discerns a USB cable according to the current characteristic of current “300 mA,” which is input through the serial resistors (600 Ω+400 Ω) in the resistance circuit unit and is analyzed.

The controller performs a control operation such that power is received through the discerned TA or USB cable from a corresponding charging device, and the battery is charged with the received power in step 750.

While the present invention has been described about a case where the serially connected resistors in the resistance circuit unit are used to discern a travel adaptor and a USB cable from each other in order to discern the charging cable, the parallel connected resistors in the resistance circuit unit may be used to discern the charging cable.

According to exemplary embodiments of the present invention as described above, the switch is turned on or off according to a logic characteristic value output from the logic circuit, and the current characteristic of current passing through the resistance circuit according to the on/off operation of the switch is analyzed, thereby accurately discerning a charging cable connected to charge a power source in the portable communication device.

In addition, since the power source in the portable communication device is charged through the accurately discerned charging cable, it is possible to prevent the portable communication device or battery from being damaged due to unstable power of a charging device.

The portable communication device and method for charging through discernment of a charging cable according to exemplary embodiments of the present invention can be implemented as described above. While the present invention has been shown and described with reference to certain exemplary embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A portable communication device for charging through discernment of a charging cable, the portable communication device comprising:
a connector for connecting to an external charging device in order to charge a power source in the portable communication device;
a charging unit for charging a battery with power input from the external charging device through the connector; and
a controller for discerning a charging cable by analyzing a current characteristic according to a configuration signal input from the external charging device through the connector, and for controlling the battery to be charged from the external charging device through the discerned charging cable.

2. The portable communication device as claimed in claim 1, wherein the controller comprises:
a logic circuit unit for outputting a logic characteristic value according to the configuration signal of the external charging device, which is input through a positive data line and a negative data line of the connector;
a switch unit for switching according to the logic characteristic value output from the logic circuit unit; and
a resistance circuit unit for enabling the current characteristic to be analyzed according to the switching of the switch unit.

3. The portable communication device as claimed in claim 2, wherein, when the controller receives a configuration signal of a high level through both the positive data line and the negative data line of the connector from the external charging device, the switch unit is switched on according to a high logic signal output from the logic circuit unit, and a current characteristic through the resistance circuit unit, which is connected by the switch unit, is analyzed as shown in
I=V/R1
in which “I” represents a current value, “V” represents a voltage value, and “R1” represents a resistance value.

4. The portable communication device as claimed in claim 3, wherein the controller discerns a travel adaptor according to the current characteristic and controls the battery to be charged from the external charging device.

5. The portable communication device as claimed in claim 3, wherein, when the controller receives a configuration signal, which swings from a high level to a low level and from a low level to a high level through the positive data line and the negative data line of the connector respectively, from the external charging device, the switch unit is switched off according to a low logic signal output from the logic circuit unit, and a current characteristic through the resistance circuit unit is analyzed as shown in
I=V/R1+R2.

6. The portable communication device as claimed in claim 5, wherein the controller discerns a USB cable according to the current characteristic and controls the battery to be charged from the external charging device.

7. The portable communication device as claimed in claim 2, wherein, when the controller receives a configuration signal of a high level through both the positive data line and the negative data line of the connector from the external charging device, the switch unit is switched on according to a high logic signal output from the logic circuit unit, and a current characteristic through the resistance circuit unit, which is connected by the switch unit, is analyzed as shown in
I=V/(R1//R2),
in which “I” represents a current value, “V” represents a voltage value, and “R1” and “R2” represent a resistance value.

8. The portable communication device as claimed in claim 7, wherein the controller discerns a travel adaptor according to the current characteristic and controls the battery to be charged from the external charging device.

9. The portable communication device as claimed in claim 7, wherein, when the controller receives a configuration signal, which swings from a high level to a low level and from a low level to a high level through the positive data line and the negative data line of the connector, from the external charging device, the switch unit is switched off according to a low logic signal output from the logic circuit unit, and a current characteristic through the resistance circuit unit is analyzed as shown in
I=V/R1.

10. The portable communication device as claimed in claim 9, wherein the controller discerns a USB cable according to the current characteristic and controls the battery to be charged from the external charging device.

11. A method for charging through discernment of a charging cable in a portable communication device, the method comprising:
connecting the portable communication device to an external charging device through a connector in order to charge a power source in the portable communication device;
receiving a configuration signal from the external charging device through a positive data line and a negative data line of the connector;
outputting a logic characteristic value according to the received configuration signal;
configuring a resistance circuit unit by performing a switching operation according to the logic characteristic value;
discerning a charging cable by analyzing a current characteristic of the resistance circuit unit; and
controlling a battery to be charged from the external charging device through the discerned charging cable.

12. The method as claimed in claim 11, wherein, the discerning of the charging cable comprises, when a configuration signal of a high level is received through both the positive data line and the negative data line of the connector from the external charging device, the switching is performed according to a high logic signal output from the logic circuit unit, and a current characteristic through the resistance circuit unit is analyzed as shown in
I=V/R1,
thereby discerning a travel adaptor,
in which “I” represents a current value, “V” represents a voltage value, and “R1” represents a resistance value.

13. The method as claimed in claim 12, wherein, the discerning of the charging cable comprises, when a configuration signal, which swings from a high level to a low level and from a low level to a high level through the positive data line and the negative data line of the connector, is received from the external charging device, the switching is performed according to a low logic signal output from the logic circuit unit, and a current characteristic through the resistance circuit unit is analyzed as shown in
I=V/R1+R2,
thereby discerning a USB cable.

14. The method as claimed in claim 11, wherein, the discerning of the charging cable comprises, when a configuration signal of a high level through both the positive data line and the negative data line of the connector is received from the external charging device, the switching is performed according to a high logic signal output from the logic circuit unit, and a current characteristic through the resistance circuit unit is analyzed as shown in
I=V/(R1//R2),
thereby discerning a travel adaptor.

15. The method as claimed in claim 14, wherein, the discerning of the charging cable comprises, when a configuration signal, which swings from a high level to a low level and from a low level to a high level through the positive data line and the negative data line of the connector, is received from the external charging device, the switching is performed according to a low logic signal output from the logic circuit unit, and a current characteristic through the resistance circuit unit is analyzed as shown in
I=V/R1,
thereby discerning a USB cable.

16. A portable communication device for discerning a charging cable, comprising:
a connector for connecting to a charging cable; and
a controller for discerning a type of the charging cable based on characteristics of a signal supplied by the charging cable.
